(19) United States
(12) Patent Application Publication
(10) Pub. No.: US 2006/0154640 A1
(43) Pub. Date: Jul. 13, 2006

(54) Image rejection mixer and terrestrial digital multimedia broadcasting tuner of low intermediate frequency structure using the same

(75) Inventors: Seung Min Oh, Suwon (KR); Yoo Sam Na, Seoul (KR); Jeong Ki Choi, Suwon (KR); Seung Won Seo, Suwon (KR); Moon Sun Kim, Suwon (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/089,226

(22) Filed: Mar. 24, 2005

(30) Foreign Application Priority Data
Jan. 11, 2005 (KR) 10-2005-2478

(51) Int. Cl. H04B 1/18; H04B 1/10

(52) U.S. Cl. 455/326; 455/285; 455/302

(57) ABSTRACT

Disclosed herein are a terrestrial digital multimedia broadcasting (DMB) tuner of a low intermediate frequency (IF) structure which is applied to a mobile communication terminal, such as a mobile phone, and an image rejection mixer applied thereto. In order to improve inter-channel attenuation characteristics, the image rejection mixer locates an oscillation frequency above or beneath the frequency of a target signal to include an image signal of the target signal in a terrestrial DMB band, mixes a radio frequency (RF) signal with the oscillation frequency, and outputs the resulting IF signals to a polyphase filter in a selected arrangement. Because the image signal of the target signal is included in the terrestrial DMB band, the image rejection mixer can satisfy the inter-channel attenuation characteristics without a troublesome or complex design.

### RELATED APPLICATIONS

The present application is based on, and claims priority from, Korean Application Number 2005-002478, filed Jan. 11, 2005, the disclosure of which is incorporated by reference herein in its entirety.

### BACKGROUND OF THE INVENTION

1. Field of the Invention

The present invention relates to a terrestrial digital multimedia broadcasting (DMB) tuner of a low intermediate frequency (IF) structure which is applied to a mobile communication terminal, such as a mobile phone, and an image rejection mixer applied thereto, and more particularly to an image rejection mixer which is capable of being implemented with a single integrated circuit (IC) by excluding an external device, so that it can be made with small size and at low cost and operated at low power, and a terrestrial DMB tuner of a low IF structure using the same.

2. Description of the Related Art

In general, digital multimedia broadcasting (DMB) refers to broadcasting capable of sending text, graphics and moving images, as well as high-quality sound of the compact disc (CD) level, over simple audio services such as existing amplitude modulation (AM) broadcasting or frequency modulation (FM) broadcasting. This DMB typically means terrestrial broadcasting that locally provides a free broadcasting service, but, roughly, also includes satellite DMB that provides a pay multimedia broadcasting service using both a satellite and terrestrial network.

The DMB adopts, for audio broadcasting, a digital audio processing or modulation system, which is very resistant to deterioration or noise, not an existing analog audio processing or modulation system. The digital audio processing system adopts an audio compression scheme of moving picture experts group (MPEG) 1 layer 2 that compresses high-volume data appropriately to transmission and storage thereof, and the digital audio modulation system adopts an orthogonal frequency division multiplexing (OFDM) scheme that provides an excellent mobile reception capability. Allocated as digital audio broadcasting (DAB) bands in Europe are a band-III (174˜240 MHz), which is a very high frequency (VHF) band, an L-band (1452˜1492 MHz), and a satellite DMB band (2630˜2655 MHz).

In contrast, a part of the band-III (174˜240 MHz) is allocated as a terrestrial DMB band in Korea. At present, TV channels belonging to the band-III, for example, a channel 10 (193˜199 MHz) and channel 12 (204˜210 MHz), are allocated as terrestrial DMB frequencies in Korea. Here, each of the channel 10 and channel 12 includes three DMB channels.

Research and development have been ceaselessly done for making a DMB tuner in the form of one application specific integrated circuit (ASIC) chip through a complementary metal-oxide semiconductor (CMOS) process using a silicon process according to a recent tendency to provide lightness, thinness, compactness and smallness. For this one-chip implementation, there is a need to make a circuit configuration of the DMB tuner as simple as possible by excluding a device difficult to make in IC form.

The configuration of a conventional terrestrial DMB tuner is shown in FIG. 1.

FIG. 1 is a circuit diagram showing the configuration of a conventional terrestrial DMB tuner.

As shown in FIG. 1, the conventional terrestrial DMB tuner comprises a band pass filter 11 for passing a radio frequency (RF) signal of a terrestrial DMB band at a predetermined band, an RF amplifier 12 for amplifying an output signal from the band pass filter 11 at a predetermined gain, and an automatic gain control (AGC) amplifier 13 having a gain which is automatically controlled according to a received signal strength. The AGC amplifier 13 acts to amplify an output signal from the RF amplifier 12 at the controlled gain. The conventional terrestrial DMB tuner further comprises a voltage controlled oscillator (VCO) 14 for generating an oscillation frequency for channel selection, a phase locked loop (PLL) 15 for controlling the oscillation frequency of the VCO 24, a mixer 16 for mixing an output signal from the AGC amplifier 13 with the oscillation frequency to generate an IF signal, an IF surface acoustic wave (SAW) filter 17 for passing the IF signal from the mixer 16 at a predetermined band, and an IF amplifier 18 for amplifying an output signal from the SAW filter 17 at a predetermined gain.

FIG. 2 is a frequency spectrum of a target signal, image signal and IF signal in the terrestrial DMB tuner of FIG. 1. With reference to FIG. 2, the conventional terrestrial DMB tuner converts an RF signal of the band-III (174˜240 MHz) into an IF signal of 38.912 MHz, which contains an image signal RFim as well as a target signal RFw. That is, the target signal RFw and the image signal RFim are located at both sides of the IF signal such that they are symmetrically spaced apart from each other by an IF about an oscillation frequency Fo.

The image signal can be removed by the band pass filter 11 because the frequency of the IF signal is high and the image signal is thus far away from the target signal at a frequency domain. Moreover, the IF signal can be selected at higher selectivity using the IF SAW filter 17.

However, the above-mentioned conventional terrestrial DMB tuner has to use the IF SAW filter having excellent selectivity even at a high frequency, since the frequency of the IF signal is high and an active filter implementable with an IC has poor selectivity at the high frequency. The use of the IF SAW filter makes it difficult to make the terrestrial DMB tuner in the form of one IC, resulting in limitations in reducing the size, cost and power consumption of the tuner.

Approaches to the exclusion of the SAW filter may be a tuner of a zero IF structure and a tuner of a low IF structure. However, the tuner of the zero IF structure has a disadvantage in that reception sensitivity is significantly degraded due to a direct current (DC) offset in the process of OFDM modulation.

### SUMMARY OF THE INVENTION

Therefore, the present invention has been made in view of the above problems, and it is an object of the present invention to provide an image rejection mixer which is capable of being implemented with a single IC by excluding an external device, so that it can be made with small size and at low cost and operated at low power, and a terrestrial DMB tuner of a low IF structure using the same, which is applied to a mobile communication terminal such as a mobile phone.

In accordance with an aspect of the present invention, the above and other objects can be accomplished by the provision of an image rejection mixer which is applicable to a terrestrial digital multimedia broadcasting (DMB) tuner and mixes a radio frequency (RF) signal with first and second oscillation signals to generate an intermediate frequency (IF) signal, the first and second oscillation signals having a phase difference of 90 degrees therebetween, the image rejection mixer comprising: a first multiplier for multiplying the RF signal by the first oscillation signal to generate first and second IF-I signals which are 180 degrees out of phase with each other; a second multiplier for multiplying the RF signal by the second oscillation signal to generate first and second IF-Q signals which are 180 degrees out of phase with each other; a signal selection unit including first and second input terminals for receiving the first and second IF-I signals, respectively, third and fourth input terminals for receiving the first and second IF-Q signals, respectively, first to fourth output terminals, a first signal selector for outputting the first and second IF-I signals to the first and third output terminals and the first and second IF-Q signals to the second and fourth output terminals, respectively, in response to a first switching signal, and a second signal selector for outputting the first and second IF-I signals to the first and third output terminals and the first and second IF-Q signals to the fourth and second output terminals, respectively, in response to a second switching signal; and a polyphase filter including first to fourth input terminals connected respectively to the first to fourth output terminals of the signal selection unit, and first to fourth output terminals, the polyphase filter removing image components contained in signals inputted through the first to fourth input terminals thereof to generate first to fourth IF signals and output them through the first to fourth output terminals thereof, respectively, whereby an image frequency lower than an oscillation frequency is removed when the first signal selector is turned on, and an image frequency higher than the oscillation frequency is removed when the second signal selector is turned on.

In accordance with another aspect of the present invention, there is provided a terrestrial DMB tuner comprising: a band pass filter for passing an RF signal of a terrestrial DMB band at a predetermined band; an RF amplification circuit for amplifying an output RF signal from the band pass filter; a phase locked loop (PLL) for controlling oscillation in response to a channel selection signal; a two-phase oscillator for generating first and second oscillation signals having a phase difference of 90 degrees therebetween under the oscillation control of the PLL; an image rejection mixer for mixing an output RF signal from the RF amplification circuit with the first and second oscillation signals to generate an IF signal and removing image components contained in the generated IF signal in response to first and second switching signals; an IF filter for passing the resulting IF signal from the image rejection mixer at a predetermined band; and an IF amplification circuit for amplifying an output IF signal from the IF filter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram showing the configuration of a conventional terrestrial DMB tuner;

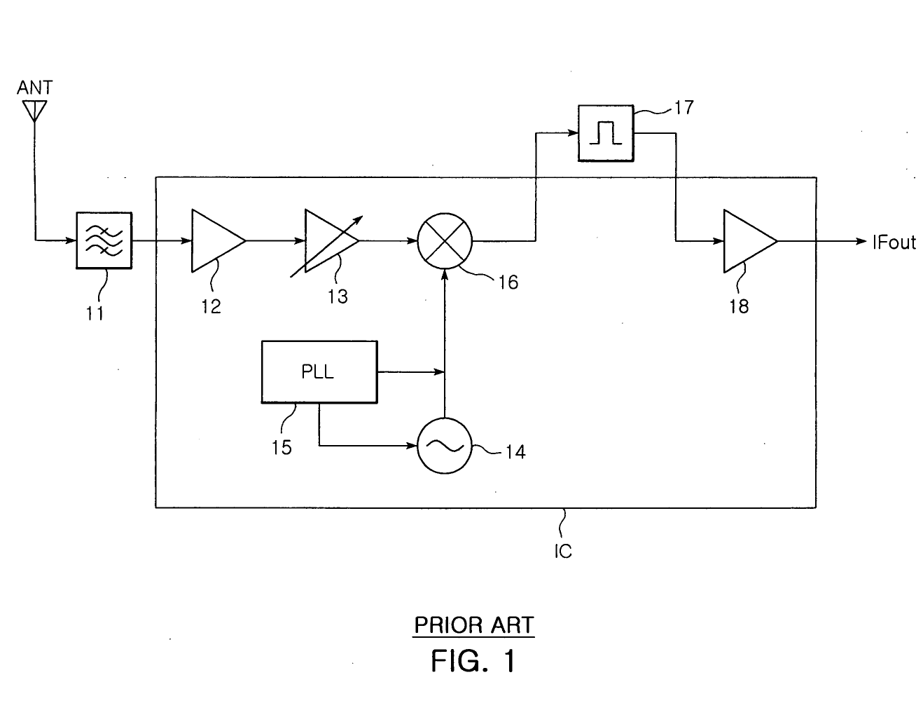

FIG. 2 is a frequency spectrum of a target signal, image signal and IF signal in the terrestrial DMB tuner of FIG. 1;

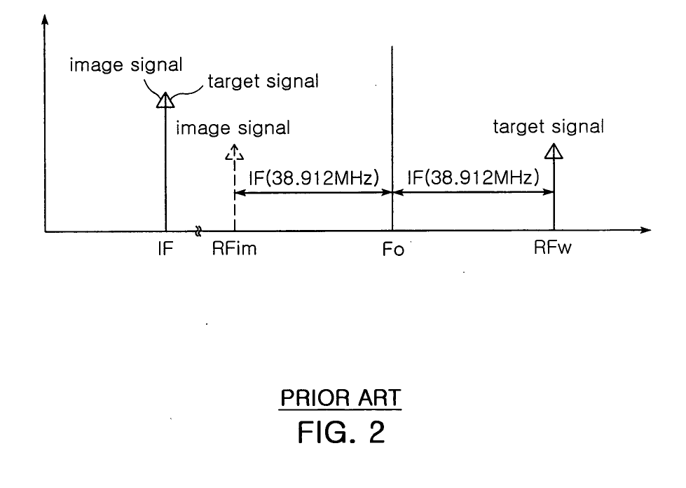

FIG. 3 is a block diagram showing the configuration of a terrestrial DMB tuner of a low IF structure according to the present invention;

FIG. 4 is a circuit diagram showing the configuration of an image rejection mixer according to the present invention;

FIG. 5 is a view illustrating band-III channel allocation and inter-channel attenuation characteristics of the terrestrial DMB tuner of the low IF structure according to the present invention; and

FIGS. 6a to 6c are views illustrating a channel selection operation of the terrestrial DMB tuner of the low IF structure according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

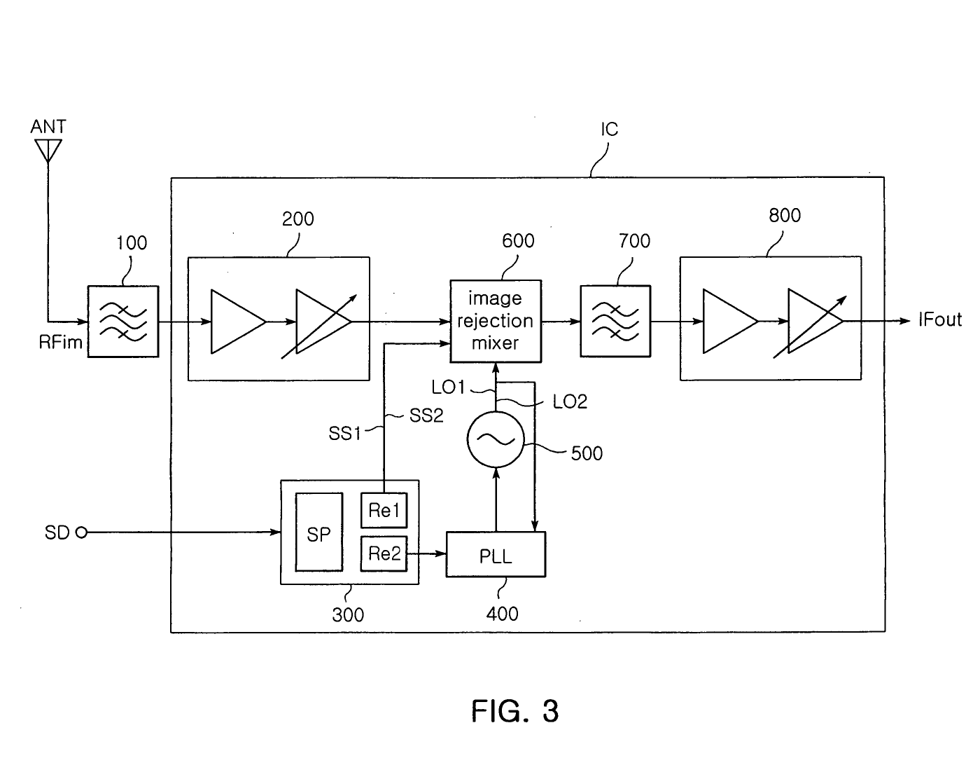

FIG. 3 is a block diagram showing the configuration of a terrestrial DMB tuner of a low IF structure according to the present invention.

With reference to FIG. 3, the terrestrial DMB tuner of the low IF structure according to the present invention comprises a band pass filter 100 for passing an RF signal of a terrestrial DMB band at a predetermined band, an RF amplification circuit 200 for amplifying an output RF signal from the band pass filter 100, an interface unit 300 for converting serial data containing a channel selection signal and first and second switching signals SS1 and SS2 into parallel data and outputting the channel selection signal and first and second switching signals SS1 and SS2 contained in the converted parallel data, a PLL 400 for controlling oscillation in response to the channel selection signal from the interface unit 300, and a two-phase oscillator 500 for generating first and second oscillation signals LO1 and LO2 having a phase difference of 90 degrees therebetween under the oscillation control of the PLL 400. The terrestrial DMB tuner of the low IF structure according to the present invention further comprises an image rejection mixer 600 for mixing an output RF signal from the RF amplification circuit 200 with the first and second oscillation signals LO1 and LO2 to generate an IF signal and removing image components contained in the generated IF signal in response to the switching signals SS1 and SS2, an IF filter 700 for passing the resulting IF signal from the image rejection mixer 600 at a predetermined band, and an IF amplification circuit 800 for amplifying an output IF signal from the IF filter 700.

Preferably, each of the RF amplification circuit 200 and IF amplification circuit 800 includes a fixed-gain amplifier with a fixed gain and/or an AGC amplifier with a gain which is automatically controlled according to a received signal strength.

The IF signal has a low IF of about 850 to 900 KHz.

The RF amplification circuit 200, interface unit 300, PLL 400, two-phase oscillator 500, image rejection mixer 600, IF filter 700 and IF amplification circuit 800, among the above-stated components, can be provided in one IC.

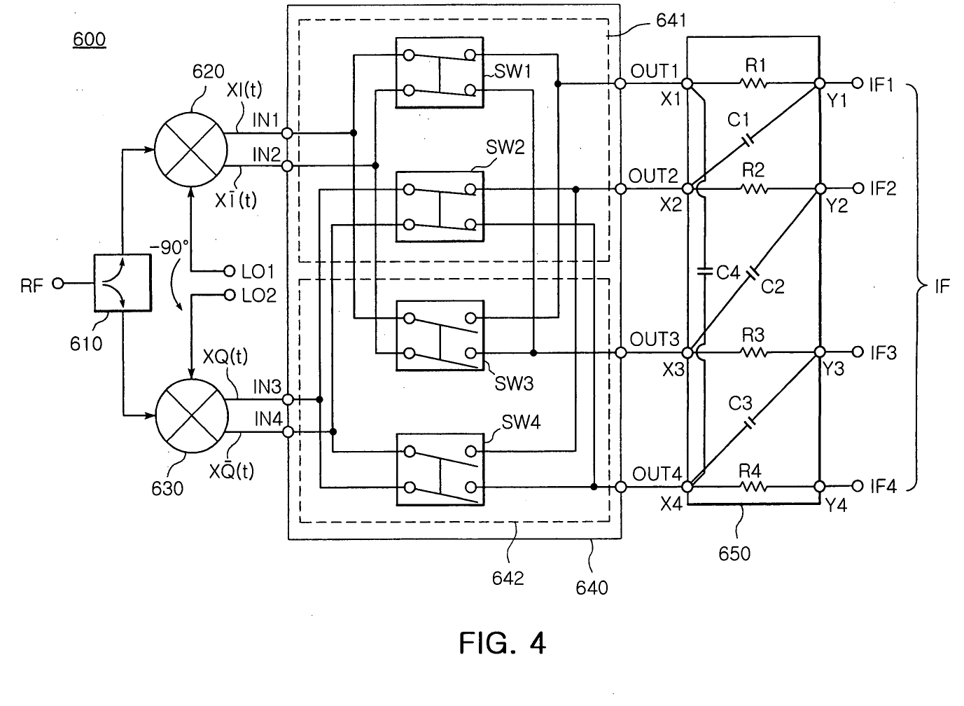

FIG. 4 is a circuit diagram showing the configuration of the image rejection mixer 600 according to the present invention.

With reference to FIG. 4, the image rejection mixer 600 according to the present invention includes a first multiplier 620, a second multiplier 630, a signal selection unit 640, and a polyphase filter 650. The image rejection mixer 600 further includes a distributor 610 for distributing the output RF signal from the RF amplification circuit 200 to the first multiplier 620 and the second multiplier 630.

In FIG. 4, the first multiplier 620 multiplies the RF signal by the first oscillation signal LO1 to generate first and second IF-I signals XI(t) and X\overline{I}(t) which are 180 degrees out of phase with each other.

The second multiplier 630 multiplies the RF signal by the second oscillation signal LO2 to generate first and second IF-Q signals XQ(t) and X\overline{Q}(t) which are 180 degrees out of phase with each other.

The signal selection unit 640 includes first and second input terminals IN1 and IN2 for receiving the first and second IF-I signals XI(t) and X\overline{I}(t), respectively, third and fourth input terminals IN3 and IN4 for receiving the first and second IF-Q signals XQ(t) and X\overline{Q}(t), respectively, first to fourth output terminals OUT1 to OUT4, a first signal selector 641 for outputting the first and second IF-I signals XI(t) and X\overline{I}(t) to the first and third output terminals OUT1 and OUT3 and the first and second IF-Q signals XQ(t) and X\overline{Q}(t) to the second and fourth output terminals OUT2 and OUT4, respectively, in response to the first switching signal SS1, and a second signal selector 642 for outputting the first and second IF-I signals XI(t) and X\overline{I}(t) to the first and third output terminals OUT1 and OUT3 and the first and second IF-Q signals XQ(t) and X\overline{Q}(t) to the fourth and second output terminals OUT4 and OUT2, respectively, in response to the second switching signal SS2.

The second signal selector 642 in the signal selection unit 640 is turned on by the second switching signal SS2 which is provided when a first DMB channel is selected, and the first signal selector 641 in the signal selection unit 640 is turned on by the first switching signal SS1 which is provided when a second or third DMB channel is selected. Alternatively, the first signal selector 641 in the signal selection unit 640 may be turned on by the first switching signal SS1 which is provided when the third DMB channel is selected, and the second signal selector 642 in the signal selection unit 640 may be turned on by the second switching signal SS2 which is provided when the first or second DMB channel is selected.

Here, one of the first switching signal SS1 and second switching signal SS2 is selectively provided as an ON signal to selectively turn on one of the first signal selector 641 and second signal selector 642.

In detail, the first signal selector 641 in the signal selection unit 640 includes a first switch SW1 which is turned on in response to the first switching signal SS1 to output the first and second IF-I signals XI(t) and X\overline{I}(t) to the first and third output terminals OUT1 and OUT3, respectively, and a second switch SW2 which is turned on in response to the first switching signal SS1 to output the first and second IF-Q signals XQ(t) and X\overline{Q}(t) to the second and fourth output terminals OUT2 and OUT4, respectively. Preferably, each of the first and second switches SW1 and SW2 is implemented with an amplifier.

The second signal selector 642 in the signal selection unit 640 includes a third switch SW3 which is turned on in response to the second switching signal SS2 to output the first and second IF-I signals XI(t) and X\overline{I}(t) to the first and third output terminals OUT1 and OUT3, respectively, and a fourth switch SW4 which is turned on in response to the second switching signal SS2 to output the first and second IF-Q signals XQ(t) and X\overline{Q}(t) to the fourth and second output terminals OUT4 and OUT2, respectively. Preferably, each of the third and fourth switches SW3 and SW4 is implemented with an amplifier.

The polyphase filter 650 includes first to fourth input terminals X1-X4 connected respectively to the first to fourth output terminals OUT1 to OUT4 of the signal selection unit 640, and first to fourth output terminals Y1 to Y4. The polyphase filter 650 acts to remove image components contained in signals inputted through the first to fourth input terminals X1-X4 to generate first to fourth IF signals IF1 to IF4 and output them through the first to fourth output terminals Y1 to Y4, respectively.

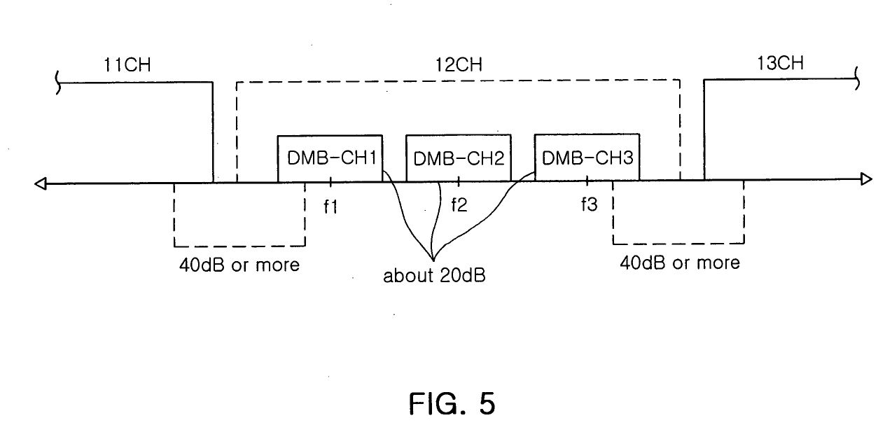

FIG. 5 illustrates band-III channel allocation and inter-channel attenuation characteristics of the terrestrial DMB tuner of the low IF structure according to the present invention. As shown in this drawing, a TV channel 10 or 12 is used for the terrestrial DMB tuner, although other TV channels may of course be used. In this case, the TV channel 10 or 12 must have attenuation characteristics of about 40 dB with other neighboring TV channels, and terrestrial DMB channels of the TV channel 10 or 12 must have attenuation characteristics of about 20 dB thereamong.

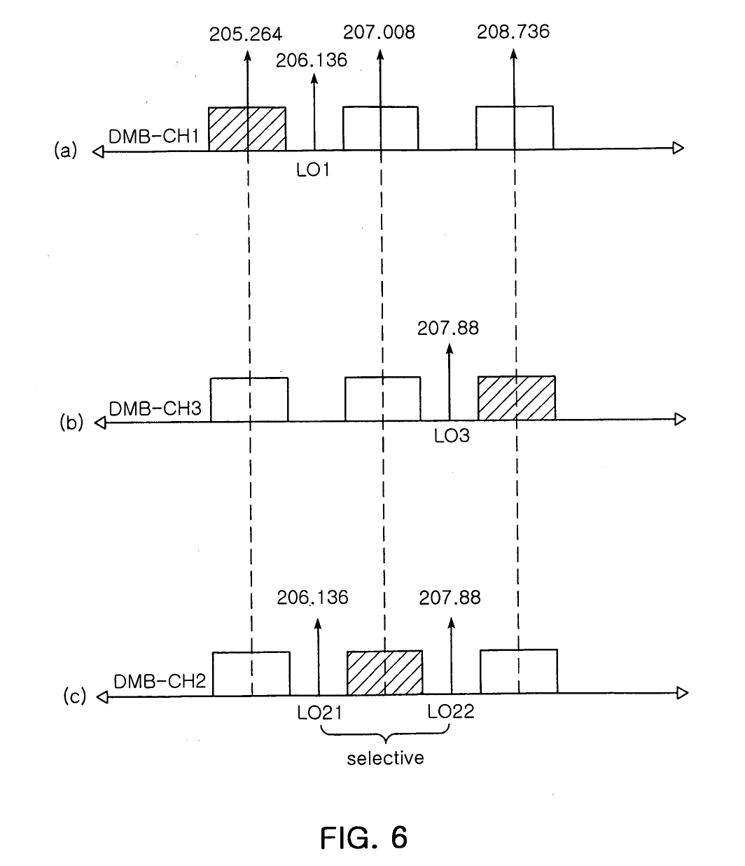

Hence, in order to satisfy the inter-channel attenuation characteristics without a troublesome or complex design, the terrestrial DMB tuner of the low IF structure according to the present invention sets an oscillation frequency to locate an image signal of a target signal in a terrestrial DMB band, as shown in FIG. 6.

FIGS. 6a to 6c illustrate a channel selection operation of the terrestrial DMB tuner of the low IF structure according to the present invention.

In the image rejection mixer of the present invention, when a first DMB channel DMB-CH1 is selected, an oscillation frequency for selection of the first DMB channel DMB-CH1 is located above the DMB channel DMB-CH1, as shown in FIG. 6a. When a second DMB channel DMB-CH2 is selected, an oscillation frequency for selection of the second DMB channel DMB-CH2 is located above or beneath the DMB channel DMB-CH2, as shown in FIG. 6c. When a third DMB channel DMB-CH3 is selected, an oscillation frequency for selection of the third DMB channel DMB-CH3 is located beneath the DMB channel DMB-CH3, as shown in FIG. 6b.

Next, the function and effect of the present invention will be described in detail in conjunction with the annexed drawings.

With reference to FIGS. 3 to 6, in the terrestrial DMB tuner of the present invention, a terrestrial DMB signal inputted through an antenna ANT is passed at a predetermined band by the band pass filter 100 and then amplified by the RF amplification circuit 200.

Meanwhile, in the terrestrial DMB tuner of the present invention, a serial/parallel converter SP of the interface unit 300 converts serial data SD containing a channel selection signal and first and second switching signals SS1 and SS2 into parallel data. A first register Re1 of the interface unit 300 outputs the switching signals SS1 and SS2 contained in the parallel data converted by the serial/parallel converter SP to the image rejection mixer 600. A second register Re2 of the interface unit 300 outputs the channel selection signal contained in the parallel data converted by the serial/parallel converter SP to the PLL 400. Here, the serial data SD is data that is provided according to channel selection in a terminal or device to which the terrestrial DMB tuner of the present invention is applied.

Thereafter, the PLL 400 controls oscillation of the two-phase oscillator 500 in response to the channel selection signal from the interface unit 300, and the two-phase oscillator 500 generates first and second oscillation signals LO1 and LO2 having a phase difference of 90 degrees therebetween under the oscillation control of the PLL 400. The two-phase oscillator 500 then outputs the generated first and second oscillation signals LO1 and LO2 to the image rejection mixer 600.

For example, as shown in FIG. 6a, when the first DMB channel DMB-CH1 contained in the channel 12 is selected, the two-phase oscillator 500 generates “206.136 MHz” as the first oscillation frequency LO1 to select a center frequency “205.264 MHz” of the first DMB channel DMB-CH1, so the image rejection mixer 600 outputs an IF signal of about 872 KHz.

As shown in FIG. 6b, when the third DMB channel DMB-CH3 contained in the channel 12 is selected, the two-phase oscillator 500 generates “207.88 MHz” as the second oscillation frequency LO2 to select a center frequency “208.736 MHz” of the third DMB channel DMB-CH3, so the image rejection mixer 600 outputs an IF signal of about 856 KHz.

Also, as shown in FIG. 6c, when the second DMB channel DMB-CH2 contained in the channel 12 is selected, the two-phase oscillator 500 selectively generates “206.136 MHz” as the first oscillation frequency LO1 or “207.88 MHz” as the second oscillation frequency LO2 to select a center frequency “207.008 MHz” of the second DMB channel DMB-CH2. As a result, the image rejection mixer 600 outputs an IF signal of about 872 KHz when the first oscillation frequency LO1 of 206.136 MHz is generated, and an IF signal of about 856 KHz when the second oscillation frequency LO2 of 207.88 MHz is generated.

Thereafter, the image rejection mixer 600 mixes an output RF signal from the RF amplification circuit 200 with the first and second oscillation signals LO1 and LO2 to generate an IF signal, removes image components contained in the generated IF signal in response to the first and second switching signals SS1 and SS2 and outputs the resulting IF signal to the IF filter 700, which will be described later in detail with reference to FIG. 4.

The IF filter 700 passes the IF signal from the image rejection mixer 600 at a predetermined band, and the IF amplification circuit 800 amplifies and outputs an output IF signal from the IF filter 700.

A detailed description will hereinafter be given of the operation of the image rejection mixer 600 with reference to FIGS. 3 and 4.

With reference to FIGS. 3 and 4, in the image rejection mixer 600, the distributor 610 distributes the output RF signal from the RF amplification circuit 200 to the first multiplier 620 and the second multiplier 630. At this time, the first multiplier 620 multiplies the RF signal by the first oscillation signal LO1 to generate first and second IF-I signals XI(t) and X\overline{I}(t) which are 180 degrees out of phase with each other. Also, the second multiplier 630 multiplies the RF signal by the second oscillation signal LO2 to generate first and second IF-Q signals XQ(t) and X\overline{Q}(t) which are 180 degrees out of phase with each other.

Thereafter, the signal selection unit 640 receives the first and second IF-I signals XI(t) and X\overline{I}(t) and the first and second IF-Q signals XQ(t) and X\overline{Q}(t) through the first to fourth input terminals IN1 to IN4, respectively, and outputs them through the first to fourth output terminals OUT1 to OUT4 in different arrangements based on the first and second switching signals SS1 and SS2 from the interface unit 300.

In more detail, the signal selection unit 640 of the present invention includes the first signal selector 641 and the second signal selector 642. The first signal selector 641 or second signal selector 642 is selectively operated in response to the first switching signal SS1 or second switching signal SS2. For example, when only the first signal selector 641 is turned on by the first switching signal SS1, the first and second IF-I signals XI(t) and X\overline{I}(t) and the first and second IF-Q signals XQ(t) and X\overline{Q}(t) are connected to the first to fourth output terminals OUT1 to OUT4 as in Table 1 below.

Alternatively, in the case where only the second signal selector 642 is turned on by the second switching signal SS2, the first and second IF-I signals XI(t) and X\overline{I}(t) and the first and second IF-Q signals XQ(t) and X\overline{Q}(t) are connected to the first to fourth output terminals OUT1 to OUT4 as in the Table 1 below.

That is, when the first signal selector 641 is turned on, an oscillation frequency is set lower than the frequency of a target signal, thereby making it possible to remove an image signal of a frequency lower than the oscillation frequency. Alternatively, when the second signal selector 642 is turned on, an oscillation frequency is set higher than the frequency of a target signal, thereby making it possible to remove an image signal of a frequency higher than the oscillation frequency.

TABLE 1

| | ARRANGEMENTS OF SIGNALS | | | |
|---|---|---|---|---|
| | OUTPUTTED THROUGH | | | |
| | OUTPUT TERMINALS OF | | | |
| | SIGNAL SELECTION UNIT | | | |
| OUTPUT TERMINALS | OUT1 | OUT2 | OUT3 | OUT4 |
| FIRST SIGNAL SELECTOR: | XI(t) | XQ(t) | X\overline{I}(t) | X\overline{Q}(t) |
| ON => LOWER OSCILLATION | | | | |
| FREQUENCY | | | | |
| SECOND SIGNAL SELECTOR: | XI(t) | X\overline{Q}(t) | X\overline{I}(t) | XQ(t) |
| ON => HIGHER OSCILLATION | | | | |
| FREQUENCY | | | | |

For example, the first signal selector 641 in the signal selection unit 640 may be turned on by the first switching signal SS1 which is provided when the second or third DMB channel is selected, and the second signal selector 642 in the signal selection unit 640 may be turned on by the second switching signal SS2 which is provided when the first DMB channel is selected.

When the second or third DMB channel is selected, the first signal selector 641 is turned on in response to the first switching signal SS1, so as to output the first and second IF-I signals XI(t) and X\overline{I}(t) to the first and third output terminals OUT1 and OUT3 and the first and second IF-Q signals XQ(t) and X\overline{Q}(t) to the second and fourth output terminals OUT2 and OUT4, respectively, as shown in the above Table 1.

In more detail, the first switch SW1 of the first signal selector 641 is turned on in response to the first switching signal SS1 to output the first and second IF-I signals XI(t) and X\overline{I}(t) to the first and third output terminals OUT1 and OUT3, respectively, and the second switch SW2 of the first signal selector 641 is turned on in response to the first switching signal SS1 to output the first and second IF-Q signals XQ(t) and X\overline{Q}(t) to the second and fourth output terminals OUT2 and OUT4, respectively.

For another example, the first signal selector 641 in the signal selection unit 640 may be turned on by the first switching signal SS1 which is provided when the third DMB channel is selected, and the second signal selector 642 in the signal selection unit 640 may be turned on by the second switching signal SS2 which is provided when the first or second DMB channel is selected.

When the first or second DMB channel is selected, the second signal selector 642 is turned on in response to the second switching signal SS2, so as to output the first and second IF-I signals XI(t) and X\overline{I}(t) to the first and third output terminals OUT1 and OUT3 and the first and second IF-Q signals XQ(t) and X\overline{Q}(t) to the fourth and second output terminals OUT4 and OUT2, respectively, as shown in the above Table 1.

In more detail, the third switch SW3 of the second signal selector 642 is turned on in response to the second switching signal SS2 to output the first and second IF-I signals XI(t) and X\overline{I}(t) to the first and third output terminals OUT1 and OUT3, respectively, and the fourth switch SW4 of the second signal selector 642 is turned on in response to the second switching signal SS2 to output the first and second IF-Q signals XQ(t) and X\overline{Q}(t) to the fourth and second output terminals OUT4 and OUT2, respectively.

The polyphase filter 650 includes the first to fourth input terminals X1-X4 connected respectively to the first to fourth output terminals OUT1 to OUT4 of the signal selection unit 640, and the first to fourth output terminals Y1 to Y4. The polyphase filter 650 removes image components contained in signals inputted through the first to fourth input terminals X1-X4 to generate first to fourth IF signals IF1 to IF4 and output them through the first to fourth output terminals Y1 to Y4, respectively.

Where the polyphase filter 650 is implemented with a four-phase filter consisting of R and C as shown in FIG. 4, it can be operated as will be described below.

First, when the third DMB channel DMB-CH3 is selected as shown in FIG. 6b, among FIGS. 6a to 6c, signals are selected as shown in the above Table 1 and then inputted to the first to fourth input terminals X1 to X4 of the polyphase filter 650 as in Table 2 below.

TABLE 2

ARRANGEMENT OF
SIGNALS INPUTTED
THROUGH INPUT
TERMINALS OF
POLYPHASE FILTER

| INPUT TERMINALS | X1 | X2 | X3 | X4 |
|---|---|---|---|---|
| SIGNALS | XI(t) | XQ(t) | X\overline{I}(t) | X\overline{Q}(t) |

For example, if an image signal “X_{A}(t)” and a target signal “X_{B}(t)” are contained in the input RF signal and X\overline{I}(t) and XQ(t) are defined as in the following equation 1, the signals at the first to fourth input terminals X1 to X4 of the polyphase filter 650 can be expressed as in the following equation 2.

$$\begin{matrix}XI ( t ) = \frac{A}{2} ∠ - 90 ° + \frac{B}{2} ∠90° \\ XQ ( t ) = \frac{A}{2} ∠0° + \frac{B}{2} ∠0° & [ Equation 1 ] \\ X 1 \text{:} XI ( t ) = \frac{A}{2} ∠ - 90 ° + \frac{B}{2} ∠ 90 ° \\ X 2 \text{:} XQ ( t ) = \frac{A}{2} ∠0° + \frac{B}{2} ∠ 0 ° \\ X 3 \text{:} X \overline{I} ( t ) = \frac{A}{2} ∠90° + \frac{B}{2} ∠ - 90 ° \\ X 4 \text{:} X \overline{Q} ( t ) = \frac{A}{2} ∠180° + \frac{B}{2} ∠ 180 ° & [ Equation 2 ]\end{matrix}$$

In the above equations 1 and 2, “A” represents image data and “B” represents target data.

Outputted at the first output terminal Y1 of the polyphase filter 650 in FIG. 4 is a signal as in the following equation 3, which is the sum of a signal obtained by legging the signal at the first input terminal X1 by a resistor R1 and a signal obtained by leading the signal at the second input terminal X2 by a capacitor C1.

Outputted at the second output terminal Y2 is a signal as in the following equation 4, which is the sum of a signal obtained by legging the signal at the second input terminal X2 by a resistor R2 and a signal obtained by leading the signal at the third input terminal X3 by a capacitor C2.

Outputted at the third output terminal Y3 is a signal as in the following equation 5, which is the sum of a signal obtained by legging the signal at the third input terminal X3 by a resistor R3 and a signal obtained by leading the signal at the fourth input terminal X4 by a capacitor C3.

Outputted at the fourth output terminal Y4 is a signal as in the following equation 6, which is the sum of a signal obtained by legging the signal at the fourth input terminal X4 by a resistor R4 and a signal obtained by leading the signal at the first input terminal X1 by a capacitor C4.

$$\begin{matrix}\begin{matrix}Y 1 = [ \frac{A}{2} ∠ - 90 ° - 45 ° + \frac{B}{2} ∠90° - 45 ° ] + \\ [ \frac{A}{2} ∠0° + 45 ° + \frac{B}{2} ∠0° + 45 ° ] \\ = B ∠45°\end{matrix} & [ Equation 3 ] \\ \begin{matrix}Y 2 = [ \frac{A}{2} ∠0° - 45 ° + \frac{B}{2} ∠0° - 45 ° ] + \\ [ \frac{A}{2} ∠90° + 45 ° + \frac{B}{2} ∠ - 90 ° + 45 ° ] \\ = B ∠135°\end{matrix} & [ Equation 4 ] \\ \begin{matrix}Y 3 = [ \frac{A}{2} ∠90° - 45 ° + \frac{B}{2} ∠ - 90 ° - 45 ° ] + \\ [ \frac{A}{2} ∠180° + 45 ° + \frac{B}{2} ∠180° + 45 ° ] \\ = B ∠ - 135 ° \\ = B ∠225°\end{matrix} & [ Equation 5 ] \\ \begin{matrix}Y 4 = [ \frac{A}{2} ∠180° - 45 ° + \frac{B}{2} ∠180° - 45 ° ] + \\ [ \frac{A}{2} ∠ - 90 ° + 45 ° + \frac{B}{2} ∠90° + 45 ° ] \\ = B ∠135°\end{matrix} & [ Equation 6 ]\end{matrix}$$

As can be seen from the above equations 3 to 6, only the target data B of the third channel is outputted under the condition that the image data A is removed.

Next, when the first DMB channel DMB-CH1 is selected as shown in FIG. 6a, signals are selected as shown in the above Table 1 and then inputted to the first to fourth input terminals X1 to X4 of the polyphase filter 650 as in Table 3 below.

TABLE 3

ARRANGEMENT
OF SIGNALS
INPUTTED THROUGH
INPUT TERMINALS
OF POLYPHASE FILTER

| INPUT TERMINALS | X1 | X2 | X3 | X4 |
|---|---|---|---|---|
| SIGNALS | XI(t) | X\overline{Q}(t) | X\overline{I}(t) | XQ(t) |

For example, if a target signal “X_{A}(t) ” and an image signal “X_{B}(t)” are contained in the input RF signal, the signals at the first to fourth input terminals X1 to X4 of the polyphase filter 650 can be expressed as in the following equation 7.

$$X 1 \text{:} XI ( t ) = \frac{A}{2} ∠ - 90 ° + \frac{B}{2} ∠ 90 ° \\ X 2 \text{:} X \overline{Q} ( t ) = \frac{A}{2} ∠180° + \frac{B}{2} ∠ 180 ° \\ X 3 \text{:} X \overline{I} ( t ) = \frac{A}{2} ∠90° + \frac{B}{2} ∠ - 90 ° \\ X 4 \text{:} XQ ( t ) = \frac{A}{2} ∠0° + \frac{B}{2} ∠ 0 ° \qquad [ Equation 7 ]$$

In the above equation 7, “A” represents target data and “B” represents image data.

Outputted at the first output terminal Y1 of the polyphase filter 650 in FIG. 4 is a signal as in the following equation 8, which is the sum of a signal obtained by legging the signal at the first input terminal X1 by the resistor R1 and a signal obtained by leading the signal at the second input terminal X2 by the capacitor C1.

Outputted at the second output terminal Y2 is a signal as in the following equation 9, which is the sum of a signal obtained by legging the signal at the second input terminal X2 by the resistor R2 and a signal obtained by leading the signal at the third input terminal X3 by the capacitor C2.

Outputted at the third output terminal Y3 is a signal as in the following equation 10, which is the sum of a signal obtained by legging the'signal at the third input terminal X3 by the resistor R3 and a signal obtained by leading the signal at the fourth input terminal X4 by the capacitor C3.

Outputted at the fourth output terminal Y4 is a signal as in the following equation 11, which is the sum of a signal obtained by legging the signal at the fourth input terminal X4 by the-resistor R4 and a signal obtained by leading the signal at the first input terminal X1 by the capacitor C4.

$$\begin{matrix}\begin{matrix}Y 1 = [ \frac{A}{2} ∠ - 90 ° - 45 ° + \frac{B}{2} ∠90° - 45 ° ] + \\ [ \frac{A}{2} ∠180° + 45 ° + \frac{B}{2} ∠180° + 45 ° ] \\ = A ∠225°\end{matrix} & [ Equation 8 ] \\ \begin{matrix}Y 2 = [ \frac{A}{2} ∠180° - 45 ° + \frac{B}{2} ∠180° - 45 ° ] + \\ [ \frac{A}{2} ∠90° + 45 ° + \frac{B}{2} ∠ - 90 ° + 45 ° ] \\ = A ∠315°\end{matrix} & [ Equation 9 ] \\ \begin{matrix}Y 3 = [ \frac{A}{2} ∠90° - 45 ° + \frac{B}{2} ∠ - 90 ° - 45 ° ] + \\ [ \frac{A}{2} ∠0° + 45 ° + \frac{B}{2} ∠0° + 45 ° ] \\ = A ∠45°\end{matrix} & [ Equation 10 ] \\ \begin{matrix}Y 4 = [ \frac{A}{2} ∠0° - 45 ° + \frac{B}{2} ∠0° - 45 ° ] + \\ [ \frac{A}{2} ∠ - 90 ° + 45 ° + \frac{B}{2} ∠90° + 45 ° ] \\ = A ∠315°\end{matrix} & [ Equation 11 ]\end{matrix}$$

As can be seen from the above equations 8 to 11, only the target data A of the first channel is outputted under the condition that the image data B is removed.

On the other hand, when the second DMB channel DMB-CH2 is selected as shown in FIG. 6c, the polyphase filter 650 performs the same operation as that for the third DMB channel if an oscillation frequency is set lower than the frequency of the second DMB channel, and the same operation as that for the first DMB channel if the oscillation frequency is set higher than the frequency of the second DMB channel.

As described above, the present invention proposes an image rejection mixer which allows an image of a selected one of DMB channels of a TV channel for terrestrial DMB to be present in the TV channel, such that it is appropriate to be applied to a terrestrial DMB tuner of a low IF structure. Therefore, the proposed image rejection mixer can be made with small size and at low cost and operated at low power. This invention also proposes a terrestrial DMB tuner with such an image rejection mixer.

FIGS. 6a to 6c illustrate the channel selection operation of the terrestrial DMB tuner of the low IF structure according to the present invention.

With reference to FIG. 6a, in the image rejection mixer of the present invention, when the first DMB channel DMB-CH1 is selected, the first signal selector 641 is turned on by the first switching signal SS1 to locate the oscillation frequency for selection of the first DMB channel DMB-CH1 above the DMB channel DMB-CH1.

With reference to FIG. 6b, in the image rejection mixer of the present invention, when the third DMB channel DMB-CH3 is selected, the second signal selector 642 is turned on by the second switching signal SS2 to locate the oscillation frequency for selection of the third DMB channel DMB-CH3 beneath the DMB channel DMB-CH3.

With reference to FIG. 6c, in the image rejection mixer of the present invention, when the second DMB channel DMB-CH2 is selected, the first signal selector 641 is turned on by the first switching signal SS1 or the second signal selector 642 is turned on by the second switching signal SS2, to locate the oscillation frequency for selection of the second DMB channel DMB-CH2 above or beneath the DMB channel DMB-CH2.

As apparent from the above description, the present invention provides a terrestrial DMB tuner which is applied to a mobile communication terminal, such as a mobile phone, and an image rejection mixer applied thereto. The image rejection mixer can be implemented with a single IC by excluding an external device, so that it can be made with small size and at low cost and operated at low power.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An image rejection mixer which is applicable to a terrestrial digital multimedia broadcasting (DMB) tuner and mixes a radio frequency (RF) signal with first and second oscillation signals to generate an intermediate frequency (IF) signal, the first and second oscillation signals having a phase difference of 90 degrees therebetween, the image rejection mixer comprising:
first multiplier for multiplying the RF signal by the first oscillation signal to generate first and second IF-I signals which are 180 degrees out of phase with each other;
a second multiplier for multiplying the RF signal by the second oscillation signal to generate first and second IF-Q signals which are 180 degrees out of phase with each other;
a signal selection unit including first and second input terminals for receiving the first and second IF-I signals, respectively, third and fourth input terminals for receiving the first and second IF-Q signals, respectively, first to fourth output terminals, a first signal selector for outputting the first and second IF-I signals to the first and third output terminals and the first and second IF-Q signals to the second and fourth output terminals, respectively, in response to a first switching signal, and a second signal selector for outputting the first and second IF-I signals to the first and third output terminals and the first and second IF-Q signals to the second and fourth output terminals, respectively, in response to a first switching signal, and a second signal selector for outputting the first and second IF-I signals to the first and third output terminals and the first and second IF-Q signals to the fourth and second output terminals, respectively, in response to a second switching signal; and
a polyphase filter including first to fourth input terminals connected respectively to the first to fourth output terminals of the signal selection unit, and first to fourth output terminals, the polyphase filter removing image components contained in signals inputted through the first to fourth input terminals thereof to generate first to fourth IF signals and output them through the first to fourth output terminals thereof, respectively,
whereby an image frequency lower than an oscillation frequency is removed when the first signal selector is turned on, and an image frequency higher than the oscillation frequency is removed when the second signal selector is turned on.

2. The image rejection mixer as set forth in claim 1, wherein:
the second signal selector in the signal selection unit is turned on by the second switching signal which is provided when a first DMB channel is selected; and
the first signal selector in the signal selection unit is turned on by the first switching signal which is provided when 25 a second or third DMB channel is selected.

3. The image rejection mixer as set forth in claim 1, wherein:
the second signal selector in the signal selection unit is turned on by the second switching signal which is provided when a first or second DMB channel is selected; and
the first signal selector in the signal selection unit is turned on by the first switching signal which is provided when a third DMB channel is selected.

4. The image rejection mixer as set forth in claim 1, wherein the first signal selector in the signal selection unit includes:
a first switch turned on in response to the first switching signal for outputting the first and second IF-I signals to the first and third output terminals of the signal selection unit, respectively; and
a second switch turned on in response to the first switching signal for outputting the first and second IF-Q signals to the second and fourth output terminals of the signal selection unit, respectively.

5. The image rejection mixer as set forth in claim 4, wherein each of the first and second switches includes an amplifier.

6. The image rejection mixer as set forth in claim 1, wherein the second signal selector in the signal selection unit includes:
a first switch turned on in response to the second switching signal for outputting the first and second IF-I signals to the first and third output terminals of the signal selection unit, respectively; and
a second switch turned on in response to the second switching signal for outputting the first and second IF-Q signals to the fourth and second output terminals of the signal selection unit, respectively.

7. The image rejection mixer as set forth in claim 6, wherein each of the first and second switches includes an amplifier.

8. A terrestrial DMB tuner comprising the image rejection mixer as set forth in claim 1.

9. A terrestrial DMB tuner comprising:
a band pass filter for passing an RE signal of a terrestrial DMB band at a predetermined band;
an RE amplification circuit for amplifying an output RE signal from the band pass filter;
a phase locked loop (PLL) for controlling oscillation in response to a channel selection signal;
a two-phase oscillator for generating first and second oscillation signals having a phase difference of 90 degrees therebetween under the oscillation control of the PLL;
an image rejection mixer for mixing an output RF signal from the RF amplification circuit with the first and second oscillation signals to generate an IF signal and removing image components contained in the generated IF signal in response to first and second switching signals;
an IF filter for passing the resulting IF signal from the image rejection mixer at a predetermined band; and
an IF amplification circuit for amplifying an output IF signal from the IF filter.

10. The terrestrial DMB tuner as set forth in claim 9, wherein the image rejection mixer includes:
a first multiplier for multiplying the output RF signal from the RF amplification circuit by the first oscillation signal to generate first and second IF-I signals which are 180 20 degrees out of phase with each other;
a second multiplier for multiplying the output RF signal from the RF amplification circuit by the second oscillation signal to generate first and second IF-Q signals which are 180 degrees out of phase with each other;
a signal selection unit including first and second input terminals for receiving the first and second IF-I signals, respectively, third and fourth input terminals for receiving the first and second IF-Q signals, respectively, first to fourth output terminals, a first signal selector for outputting the first and second IF-I signals to the first and third output terminals and the first and second IF-Q signals to the second and fourth output terminals, respectively, in response to the first switching signal, and a second signal selector for outputting the first and second IF-I signals to the first and third output terminals and the first and second IF-Q signals to the fourth and second output terminals, respectively, in response to the second switching signal; and
a polyphase filter including first to fourth input terminals connected respectively to the first to fourth output terminals of the signal selection unit, and first to fourth output terminals, the polyphase filter removing image components contained in signals inputted through the first to fourth input terminals thereof to generate first to fourth IF signals and output them through the first to fourth output terminals thereof, respectively,
whereby an image frequency lower than an oscillation frequency is removed when the first signal selector is turned on, and an image frequency higher than the oscillation frequency is removed when the second signal selector is turned on.

11. The terrestrial DMB tuner as set forth in claim 10, wherein: the second signal selector in the signal selection unit is turned on by the second switching signal which is provided when a first DMB channel is selected; and the first signal selector in the signal selection unit is turned on by the first switching signal which is provided when a second or third DMB channel is selected.

12. The terrestrial DMB tuner as set forth in claim 10, wherein: the second signal selector in the signal selection unit is turned on by the second switching signal which is provided when a first or second DMB channel is selected; and
the first signal selector in the signal selection unit is turned on by the first switching signal which is provided when a third DMB channel is selected.

13. The terrestrial DMB tuner as set forth in claim 10, wherein the first signal selector in the signal selection unit includes:
a first switch turned on in response to the first switching signal for outputting the first and second IF-I signals to the first and third output terminals of the signal selection unit, respectively; and
a second switch turned on in response to the first switching signal for outputting the first and second IF-Q signals to the second and fourth output terminals of the signal selection unit, respectively.

14. The terrestrial DMB tuner as set forth in claim 13, wherein each of the first and second switches includes an amplifier.

15. The terrestrial DMB tuner as set forth in claim 10, wherein the second signal selector in the signal selection unit includes:
a first switch turned on in response to the second switching signal for outputting the first and second IF-I signals to the first and third output terminals of the signal selection unit, respectively; and
a second switch turned on in response to the second switching signal for outputting the first and second IF-Q signals to the fourth and second output terminals of the signal selection unit, respectively.

16. The terrestrial DMB tuner as set forth in claim 15, wherein each of the first and second switches includes an amplifier.

17. A terrestrial DMB tuner comprising the image rejection mixer as set forth in claim 2.

18. A terrestrial DMB tuner comprising the image rejection mixer as set forth in claim 3.

19. A terrestrial DMB tuner comprising the image rejection mixer as set forth in claim 4.

20. A terrestrial DMB tuner comprising the image rejection mixer as set forth in claim 5.

21. A terrestrial DMB tuner comprising the image rejection mixer as set forth in claim 6.

22. A terrestrial DMB tuner comprising the image rejection mixer as set forth in claim 7.
